(19) United States
(12) Patent Application Publication
(10) Pub. No.: US 2025/0001294 A1
(43) Pub. Date: Jan. 2, 2025

(54) SYSTEM TO DETERMINE A REAL-TIME USER-ENGAGEMENT STATE DURING IMMERSIVE ELECTRONIC EXPERIENCES

(71) Applicants: Meta Platforms Technologies, LLC, Menlo Park, CA (US); WITHIN UNLIMITED, LLC, Venice, CA (US)

(72) Inventors: Aaron KOBLIN, Los Angeles, CA (US); Chris MILK, Redding, CT (US); Phillip WILLIAMS, Camas, WA (US); Scott SULLIVAN, San Francisco, CA (US)

(73) Assignees: Meta Platforms Technologies, LLC, Menlo Park, CA (US); WITHIN UNLIMITED, LLC, Venice, CA (US)

(21) Appl. No.: 18/701,184

(22) PCT Filed: Oct. 8, 2022
(86) PCT No.: PCT/US22/46132

§ 371 Date: Apr. 12, 2024

Related U.S. Application Data
(60) Provisional application No. 63/254,762, filed on Oct. 12, 2021.

(51) Int. Cl. A63F 13/52; A63F 13/428; A63F 13/54; G02B 27/01

(52) U.S. Cl. CPC A63F 13/52; A63F 13/428; A63F 13/54; G02B 27/0172

(57) ABSTRACT

A computer-implemented method for determining if a player has reached a certain level of gameplay-performance while playing a game within a virtual reality, VR, environment. The player wears a headset having a display for viewing the VR environment and an object tracking system. The headset's object tracking system is capable of tracking movement of a portion of the player in 3-D space to establish an actual-response path by the player during gameplay. The method includes calculating, at a first time, an ideal-response path of gameplay for the tracked portion of the player in 3-D space. The ideal-response path is the path that will achieve the certain level of gameplay performance. The method then compares, at a second time, the actual-response path with the calculated ideal-response path, and finally indicates, in response to a match in the comparing step, that the play has reached a certain level of gameplay performance.

### RELATED APPLICATION

This application claims the benefit of U.S. provisional patent application No. 63/254,762, filed Oct. 12, 2021, the entire contents of which are hereby fully incorporated herein by reference for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to Virtual Reality (VR), Mixed Reality (MR), and Augmented Reality (AR), hereinafter collectively referred to as “XR,” and, more particularly, to methods, systems and devices for determining if a player has reached a heightened state of gameplay, also referred to as a “flow-state,” for a particular game or computer-controlled visual experience, and for maintaining that condition for a period of time.

### BACKGROUND

Video games provide an important role as both entertainment and as teaching aids to their respective players, creating and sustaining a multi-billion-dollar per year gaming industry. People are initially drawn to particular video games for various reasons, including the intensity of the action within the game, the quality of the graphics, the sophistication and interest of the storyline, the satisfaction of achieving a level of gaming skill, and, of course, how fun the game is to play. Regardless of the reasons why gamers are initially drawn to play a particular game, owing to the huge annual revenue at stake, the gaming industry is equally determined to ensure that the players return to play the same game again and again. To this end, there is great interest in learning why players of a particular game return to play the same game again, and how this so-called “gamer-retention” phenomenon can be at least maintained and even improved.

As with any profitable industry, the members of the gaming industry each struggle to capture and hold a majority of gamers' interest and retention with their particular game offerings. Gaming revenue of any particular game is directly related (or indirectly related through online advertisement opportunities) to the number of gamers initially downloading the game (including uploading the game from a memory device, e.g., disc, or cartridge, etc.), and the number of times established gamers return to play the same game. The gaming industry is all too aware of the fact that if online gamers do not experience a minimum level of enjoyment and satisfaction in playing, they will not return to play the same game, and will likely not extend any related game-subscription.

A gamer who continues to return to play a particular game, is likely one who has experienced a moment of time wherein they are deeply focused and fully absorbed while playing the game. During this time, when the player experiences a kind of fluidity between the body and the mind, the player has likely reached what is often referred to as a “flow-state” while playing the game. The term “flow state” was apparently in reference to a feeling like “floating down a river.” Any gamer may find enjoyment at playing a certain game and after playing the game several times, the player will become comfortable and familiar with the rules and how to play the game. After the player fully understands the challenges of the game and what to expect based on their current skill level, they now may be able to reach a flow-state, a point during which they feel like they are playing “in the zone.”

First defined in the 1970s, by the psychologist Mihaly Csikszentmihalyi, the concept of a flow-state refers to optimal and very pleasing activities experienced by individuals, wherein they reach an intense level of concentration and involvement and wherein the normal sense of the passage of time is muted. Gamers who reach a flow-state while playing a game, later describe the experience as a state wherein self-consciousness vanishes and a favorable state of mind is reached. They become “in the zone” and they almost always perform very well during the game, often reaching high scores.

There have been many attempts to detect, in real-time, when a player has reached a flow-state while playing a particular game, but such efforts have been fraught with failure and inaccuracies. In past studies, gamers were often interviewed immediately after playing a test game, during which they were asked questions regarding any identifiable characteristics of potential flow-state awareness. Unfortunately, relying on a gamer's memory of past events during gameplay has proven to be unreliable and offered little help in better understanding the phenomenon of flow-state. During other studies, gamers were provided with various sensors such as eye-tracking sensors in an attempt to predict when a player entered a flow-state during gameplay. Unfortunately, using such sensors themselves proved difficult owing to the complex nature of the types of games during which players experience a flow-state, and the fact that different players may experience flow-state differently. For example, during a typical first-person shooter video game, a player is meant to continuously move their point of view within the gaming environment, while continuously moving their head and eyes in the real world, as they quickly search all around in the game environment for potential targets and threats. They then have to be ready to run from, or otherwise dodge any local threat or danger, and shoot any identified targets. During a VR experience, it may be possible to detect eye-movement and head movement (such as head “bobbing”) in an effort to determine a flow-state, but owing to the complexity of typical game activity, any tracking data collected fails to detect a flow-state of the player. For these types of games, it appears that current biometric sensors cannot accurately determine if a player has reached a flow-state when used alone.

It is an object of this invention to determine, in real-time, when a player of a computer-controlled video experience, such as a video game, is nearing, or has reached, a level of performance, which may be an indicator of a flow-state.

It is another object of this invention to establish an ideal player-response for a select sequence of interactive gaming events.

It is another object of this invention to measure an actual player-response of a player during a select sequence of interactive gaming events.

It is yet another object of this invention to compare an actual player response to an ideal player-response for a common select sequence of interactive gaming events to determine a level of performance.

### SUMMARY

The present invention is specified in the claims as well as in the below description. Preferred embodiments are particularly specified in the dependent claims and the description of various embodiments.

A system of one or more computers may be configured to perform particular operations or actions by virtue of having software, firmware, hardware, or a combination of them installed on the system that, in operation, causes the system to perform the actions. One or more computer programs may be configured to perform particular operations or actions by virtue of including instructions that, when executed by data processing apparatus, cause the apparatus to perform the actions.

One general aspect includes a computer-implemented method for determining if a certain level of gameplay-performance of a player has been reached while using a computer system to play a game within a virtual reality environment. The player wears a headset having a display for viewing the VR environment and an object tracking system. The object tracking system of the headset being capable of tracking movement of a portion of the player in 3-D space to establish an actual-response path by the player during gameplay. The method comprises a) calculating, at a first time, an ideal-response path of gameplay for the tracked portion of the player in 3-D space to follow in order for the player to achieve a certain level of gameplay performance. The method further comprises b) comparing, at a second time, the actual-response path with the calculated ideal-response path, and c) indicating, in response to a match in the comparing step, that the certain level of gameplay performance has been reached by the player.

Other embodiments of this aspect include corresponding computer systems,

apparatus, and computer programs recorded on one or more computer storage devices, each configured to perform the actions of the methods.

Implementations may include one or more of the following features, alone and/or in combination(s):
The method where music is played to the player at a first volume level.
The method where the volume level of the music is changed in response to the player reaching the predetermined level of performance.
The method where at least one visual characteristic of the VR environment is changed in response to the player reaching the predetermined level of performance.
The method where the at least one visual characteristic includes blurring at least a portion of the image that makes up the VR environment.
The method where the at least one visual characteristic includes darkening at least a portion of the image that makes up the VR environment.
The method where the at least one visual characteristic includes changing at least 50% of the pixels of the image that makes up the VR environment to a common color.
The method where the changing step includes attenuating the music volume level from the first volume level to a lower second volume level.
The method where the changing step includes increasing the music volume level from the first volume level to a higher third volume level.
The method where changing at least one visual characteristic of the VR environment includes displaying a graphic image which aligns with a sponsor's product or service campaign for the player to view during gameplay.
The method where the handheld implement transforms to a shape or image that conveys a particular sponsor's brand.
The method where the calculating step includes calculating the ideal-response path of gameplay for the tracked select portion of the player over a prescribed first period of time.
The method where the calculating step includes calculating the ideal-response path of gameplay for the tracked select portion of the player over a prescribed first and second periods of time.
The method where the select portion of the player being tracked includes the player's facial muscles.
The method where the select portion of the player being tracked includes the player's feet.
The method where the select portion of the player being tracked includes monitoring any sounds from the player mouth.
The method where the gameplay includes first and second levels of difficulty.
The method includes a changing step where the first level of difficulty is changed to the second level of difficulty in response to the predetermined level of gameplay performance being reached.

Another general aspect includes a computer-implemented method for teaching a person how to perform a specific series of motions while using a computer system within a virtual reality (VR) environment, wherein the person wears a headset having a display defining a field of view for viewing the VR environment and at least one handheld controller, the headset includes a tracking system for tracking the movement and location of the at least one handheld controller, the method comprising, a) generating an avatar within the VR environment so that the avatar is positioned virtually adjacent to the virtual person within the field of view of the person, and b) moving the avatar so that the avatar performs the specific series of motions, allowing the person to view the avatar and learn the specific series of motions.

Implementations may include one or more of the following features, alone and/or in combination(s):
The method, wherein the avatar is less than 100% opaque.

Another general aspect includes a controller device for use with VR system comprising a) a handle having a grip surface which is sized and shaped to be held by the hand of a user, and b) a moisture sensor located on the grip portion of the handle, the sensor being designed to measure the moisture level located between the hand of a user and the grip surface.

Another general aspect includes a controller device a controller for use with VR system comprising a) a handle having a grip surface which is sized and shaped to be held by the hand of a user, and b) a skin-temperature sensor located on the grip portion of the handle, the sensor being designed to measure the temperature of the skin of the hand of a user against the grip surface.

Another general aspect includes a controller for use with VR system comprising a) a handle having a grip surface which is sized and shaped to be held by the hand of a user, and b) a pressure sensor located on the grip portion of the handle, the sensor being designed to measure the pressure of the hand of a user against the grip surface.

Below is a list of process (method) embodiments. Those will be indicated with the letter “P”. Whenever such embodiments are referred to, this will be done by referring to “P” embodiments.
P1. A computer-implemented method for determining if a predetermined level of performance of a player has been reached while using a computer system to play a game within a virtual reality (VR) environment, wherein the player wears a headset having a display for viewing the VR environment and an object tracking system, the object tracking system being capable of tracking movement of a select portion of the player in 3-D space to establish an actual-response path by the player during gameplay,
the method comprising:
calculating, at a first time, an ideal-response path of gameplay for the tracked select portion of the player to follow in order for the player to achieve the predetermined level of performance;
comparing, at a second time, the actual-response path with the calculated ideal-response path; and
indicating, in response to a match in the comparing step, that the predetermined level of gameplay performance has been reached by the player.
P2. The computer-implemented method of any of the method embodiments, further comprising music being played to the player at a first volume level.
P3. The computer-implemented method of any of the method embodiments, further comprising the step of:
changing the volume level of the music in response to the player reaching the predetermined level of performance.
P4. The computer-implemented method of any of the method embodiments, further comprising the step of:
changing at least one visual characteristic of the VR environment, in response to the indicating step indicating that the player has reached the predetermined level of performance.
P5. The computer-implemented method of any of the method embodiments, further comprising the step of:
changing at least one visual characteristic of the VR environment, in response to the indicating step indicating that the player has reached the predetermined level of performance.
P6. The computer-implemented method of any of the method embodiments, wherein the at least one visual characteristic includes blurring at least a portion of the image that makes up the VR environment.
P7. The computer-implemented method of any of the method embodiments, wherein the at least one visual characteristic includes darkening at least a portion of the image that makes up the VR environment.
P8. The computer-implemented method of any of the method embodiments, further comprising music being played to the player at a first volume level.
P9. The computer-implemented method of any of the method embodiments, wherein the at least one visual characteristic includes changing at least 50% of the pixels of the image that makes up the VR environment to a common color.
P10. The computer-implemented method of any of the method embodiments, wherein the changing step includes attenuating the music volume level from the first volume level to a lower second volume level.
P11. The computer-implemented method of any of the method embodiments, wherein the changing step includes increasing the music volume level from the first volume level to a higher third volume level.
P12. The computer-implemented method of any of the method embodiments, wherein changing at least one visual characteristic of the VR environment includes displaying a graphic image which aligns with a sponsor's product or service campaign image for the player to view during gameplay.
P13. The computer-implemented method of any of the method embodiments, wherein the handheld implement transforms to a shape or image that conveys a particular sponsoring brand.
P14. The computer-implemented method of any of the method embodiments, wherein the calculating step includes calculating the ideal-response path of gameplay for the tracked select portion of the player over a prescribed first period of time.
P15. The computer-implemented method of any of the method embodiments, wherein the calculating step includes calculating the ideal-response path of gameplay for the tracked select portion of the player over a prescribed first and second periods of time.
P16. The computer-implemented method of any of the method embodiments, wherein the select portion of the player being tracked includes the player's facial muscles.
P17. The computer-implemented method of any of the method embodiments, wherein the select portion of the player being tracked includes the player's feet.
P18. The computer-implemented method of any of the method embodiments, wherein the select portion of the player being tracked includes monitoring any sounds emanating from the player mouth.
P19. The computer-implemented method of any of the method embodiments, wherein the gameplay includes a first level of difficulty and a second level of difficulty, and further includes a step of changing from the first level of difficulty to the second level of difficulty, the changing step being in response to the indicating step indicating that the predetermined level of gameplay performance was reached.
P20. The computer-implemented method of any of the method embodiments, for teaching a person how to perform a specific series of motions while using a computer system within a virtual reality (VR) environment, wherein the person wears a headset having a display defining a field of view for viewing the VR environment and at least one handheld controller, the headset includes a tracking system for tracking the movement and location of the at least one handheld controller, the method comprising:
generating an avatar within the VR environment so that the avatar is positioned virtually adjacent to the virtual person within the field of view of the person; Moving the avatar so that the avatar performs the specific series of motions, allowing the person to view the avatar and learn the specific series of motions.
P21. The computer-implemented method of any of the method embodiments, wherein the avatar is less than 100% opaque.

Below are device embodiments, indicated with the letter “D”.
D22. A device, comprising:
(a) hardware including memory and at least one processor, and
(b) a service running on the hardware, wherein the service is configured to perform the method of any of the preceding method embodiments P1-P13.
D23. A controller for use with VR system comprising:
a handle having a grip surface which is sized and shaped to be held by the hand of a user; and
a moisture sensor located on the grip portion of the handle, the sensor being designed to measure the moisture level located between the hand of a user and the grip surface.
D24. A controller for use with VR system comprising:
a handle having a grip surface which is sized and shaped to be held by the hand of a user; and
a skin-temperature sensor located on the grip portion of the handle, the sensor being designed to measure the temperature of the skin of the hand of a user against the grip surface.
D25. A controller for use with VR system comprising:
a handle having a grip surface which is sized and shaped to be held by the hand of a user; and
a pressure sensor located on the grip portion of the handle, the sensor being designed to measure the pressure of the hand of a user against the grip surface.
D25′. A controller for use with VR system comprising:
a handle having a grip surface which is sized and shaped to be held by the hand of a user; and
one or a combination of:
   (i) a moisture sensor located on the grip portion of the handle, the sensor being designed to measure the moisture level located between the hand of a user and the grip surface; and/or
   (ii) a skin-temperature sensor located on the grip portion of the handle, the sensor being designed to measure the temperature of the skin of the hand of a user against the grip surface; and/or
   (iii) a pressure sensor located on the grip portion of the handle, the sensor being designed to measure the pressure of the hand of a user against the grip surface.

Below is an article of manufacture embodiment, indicated with the letter “M”.
M26. An article of manufacture comprising non-transitory computer-readable media having computer-readable instructions stored thereon, the computer readable instructions including instructions for implementing a computer-implemented method, the method operable on a device comprising hardware including memory and at least one processor and running a service on the hardware, the method comprising the method of any one of the preceding method embodiments P1-P21.

Below is computer-readable recording medium embodiment, indicated with the letter “R”.
R27. A non-transitory computer-readable recording medium storing one or more programs, which, when executed, cause one or more processors to, at least: perform the method of any one of the preceding method embodiments P1-P21.

The above features, along with additional details of the invention, are described further in the examples herein, which are intended to further illustrate the invention but are not intended to limit its scope in any way.

### BRIEF DESCRIPTION OF THE DRAWINGS

Objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIG. 1 depicts aspects of a virtual reality game/system according to exemplary embodiments hereof;

FIG. 2 is a front, first-person view of a player playing an exemplary video game, including a first sequence of target objects to be hit with a baton in a defined swing direction, according to exemplary embodiments hereof;

FIG. 3 is a front perspective view of FIG. 2, showing the direction of movement towards the player during gameplay, including illustrative planes to help understand their spatial separation, according to exemplary embodiments hereof;

FIG. 4 is a front perspective view similar to FIG. 3, including a predetermined ideal player response path necessary to properly hit each of the three advancing targets using the player's baton, according to exemplary embodiments hereof;

FIG. 5 is a front, first person view, similar to FIG. 2, showing the predetermined ideal player response path of FIG. 3, from the player's perspective, according to exemplary embodiments hereof;

FIG. 6 is a front, first person view, similar to FIG. 5, showing an exemplary actual player response path by the player during gameplay, according to exemplary embodiments hereof;

FIG. 7 is a side view of the object of the exemplary video game and a portion of an ideal player response path used to illustrate an example of rules used to define an ideal player response path, according to exemplary embodiments hereof;

FIG. 8 is a perspective view of a second array of objects being projected towards a player and baton, and an ideal player response path, according to exemplary embodiments hereof;

FIG. 9 is a schematic showing a list of steps used to estimate a level of flow-state of a player of a game, according to exemplary embodiments hereof;

FIG. 10 is a perspective view of a controller, according to exemplary embodiments hereof;

FIG. 11 is a perspective view of an exemplary product-sponsorship, according to exemplary embodiments; and

FIG. 12 is a logical block diagram depicting aspects of a computer system.

### DETAILED DESCRIPTION OF THE PREFERRED EXEMPLARY EMBODIMENTS

### a) Glossary and Abbreviations

As used herein, unless used otherwise, the following terms or abbreviations have the following meanings:

Augmented Reality (AR) means an interactive experience of a real-world environment where select objects that reside in the real world are enhanced by computer-generated perceptual information, often across multiple sensory modalities, such as visual, auditory, and haptic.

Virtual Reality (VR) means an interactive experience wherein a person interacts within a computer-generated, three-dimensional environment, a “virtual world,” using electronic devices, such as hand-held controllers.

Mixed Reality (MR) means an interactive system that uses both virtual reality and augmented reality technologies to create an environment where physical and virtual objects may exist and interact in real-time.

Mechanism: A mechanism refers to any device(s), process(es), routine(s), service(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered to be shorthand for the term device(s) and/or process(es) and/or service(s).

Flow-State: means a state of mind in which a person becomes fully immersed in an activity and where the person experiences a high degree of clarity and purpose.

Flow-Spectrum: refers to varying degrees of a flow-state.

Controller: refers to the hand-held devices that compliment a VR system. Each controller communicates with the VR headset, sending location and orientation data so that the VR system knows exactly where the player's hands are located.

Tracking Sensor: refers to a type of motion or optical sensor designed to detect movement of a body part, such as muscles or eye movements.

Beat Map: refers to a visual layout of a beat or tempo of a score of music.

A.I.: Artificial Intelligence

### b) Description

In the following, exemplary embodiments of the invention will be described, referring to the figures. These examples are provided to provide further understanding of the invention, without limiting its scope.

In the following description, a series of features and/or steps are described. The skilled person will appreciate that unless required by the context, the order of features and steps is not critical for the resulting configuration and its effect. Further, it will be apparent to the skilled person that irrespective of the order of features and steps, the presence or absence of time delay between steps, may be present between some or all of the described steps.

It will be appreciated that variations to the foregoing embodiments of the invention may be made while still falling within the scope of the invention. Alternative features serving the same, equivalent, or similar purpose may replace features disclosed in the specification, unless stated otherwise. Thus, unless stated otherwise, each feature disclosed represents one example of a generic series of equivalent or similar features.

By way of introduction, a player playing a conventional video game using, for example, a personal computer (PC), experiences video images that represent a game environment (or game setting) and a gaming action (actual player response), displayed on a two-dimensional monitor. In such instance, the game developers typically rely on vanishing point perspectives and varying object size and position to create an illusion of a three-dimensional environment, displayed on a two-dimensional monitor. As the player, using this format and hardware, moves their controllers to interact with the objects displayed on the monitor, according to the rules of the particular game, the player will enjoy a limited level of realism, as they play the game. The player uses controllers to manipulate the objects within the gaming environment. During a normal gaming session and using unmodified hardware, there are no motion sensors, tracking sensors or other biometric sensors provided during gameplay. Therefore, during normal, non-modified gameplay of so-called PC games, biometric responses of a player are simply not available to interpret, as the player interacts with the game in real time. To this end, and prior to the herein-described exemplary embodiments, determining a level of flow-state of a player playing a PC game may be difficult to achieve without the use of various biometric, orientation and/or movement sensors.

Although the term “game” is used throughout this description, the present technology may be applied to a variety of electronic devices and immersive experiences, including, but not limited to, games, educational interactions, such as online teaching of math or languages, fitness-related activities using electronic devices, such as the below-described fitness program, for use with a virtual reality headset called “Supernatural,” and even business activities. For reasons of simplicity and clarity, all the applications of exemplary embodiments hereof are referred to as “games” and “gaming” in this application.

With the development of virtual reality (VR) and with recent improvements of accurate inertial sensors, high resolution displays, and specifically-developed 3-D software, a player playing a VR game may become a truly immersive and often emotional experience. The hardware requirements to achieve a truly immersive, interactive and realistic gaming experience lends itself perfectly to providing invaluable biometric and accurate body movement information, in real time, without adding additional sensors. For example, a popular VR system called the Quest 2, designed and manufactured by Oculus, a brand of Facebook Technologies, Inc., located in Menlo Park, California, includes a VR headset and two handheld wireless controllers. This VR headset includes forward-facing cameras, a gyroscope and accelerometer (also called an IMU or Inertial Measurement Unit), and an array of infrared LEDs and another IMU located within each hand controller. These sensors are very accurate and provide precise orientation and position information of both the headset and each controller, in 3-D space, essentially in real time (updated 1,000 times per second) during gameplay. Game developers of VR games use this information to effectively establish the location and orientation of the player's head, their hands and fingers in real time during a game. The software developers create virtual handheld objects, such as tennis rackets or batons, which only appear in the VR world, as seen by the player, through the VR headset. The virtual handheld objects are directly controlled by the player's hand movements in the real world. Therefore, the location, orientation, speed and direction of movement of the virtual handheld objects, in real time, are known as well.

The use of a VR system allows a player's senses to become truly isolated from the surrounding real-world environment. By wearing a typical VR headset, the player may only view the images that are presented by the VR system, similar to the focus an audience gains when watching a movie in a dark movie theater. The VR headset effectively provides a 3-Dimensional movie theater experience. The VR system also provides sound input for the player's ears, thereby further enhancing the sense that the experience is real. By controlling both visual and auditory inputs to a player, and effectively separating the player from real-world sensory inputs (i.e., real-world distractions), VR games offer a player a greater chance to focus, improve gaming performance, and reach a flow-state, compared to playing more conventional gaming formats, such as PC games.

Owing to the several accurate movement, orientation, speed, and tracking sensors already integrated within a typical VR system, important feedback information may easily be collected and evaluated in real time. This offers opportunities to discreetly evaluate a player playing a VR game to try to determine in real time if that player is approaching or has reached a level of flow-state during gameplay. However, Applicants have recognized the challenges of doing so. For example, measurable characteristics of one player reaching a certain level of flow-state may differ from those of other players and these characteristics may also be different when playing different types of games. As a second example, during first-person shooter games, a player reaching a flow-state may reveal an elevated heart rate and perhaps also experience quick head and eye movements, yet show entirely different biometrics and movement signatures for less-intense games. Based on this inconsistency, and according to exemplary embodiments hereof, the approach for detecting a player in a flow-state is not to search for the indicators that promote or yield a flow-state, but instead, search for the resulting high level of performance of gameplay, when a player reaches a flow-state. Applicants have recognized that not every player playing a game well will be in a flow-state, but every player playing a game during a flow-state will be playing well.

To help explain this inventive technology, a representative fitness game is illustrated in the accompanying figures. It should be noted that the present technology may be applied to a variety of games and even non-game related online or computer activities, and that the game shown in the figures and described below is merely a representative one. This particular game shown in the figures is a virtual reality fitness game called “Supernatural.” It was developed by, and is currently available from, a company called Within, Inc., located in Los Angeles, California. In this particular game, a player dons a suitable virtual reality headset and hand controllers, such as the above-identified Quest 2, by Facebook's Oculus brand.

Once the Supernatural game begins, a three-dimensional environment image, such as a mountain setting, is automatically generated and displayed within the player's headset, placing the player at a center point within this computer-generated virtual environment, as is well known by those of ordinary skill in the art of VR technology. The player will experience this virtual environment as a realistic three-dimensional image, one that may be viewed in all directions, as if the player were standing in the same environment in the real world. As the player moves their head left and right, up and down, the above-described sensors located within the VR headset will detect this head movement in minute resolution. The running software program (e.g., Supernatural) will collect and analyze this sensor data to immediately adjust the displayed environment image to match the exact minute increments of head movement, and also the direction and speed of the player's head to accurately create an illusion of presence. The illusion may be sufficient to convince the player that they are truly part of the virtual world being displayed, literally right in front of the player's eyes.

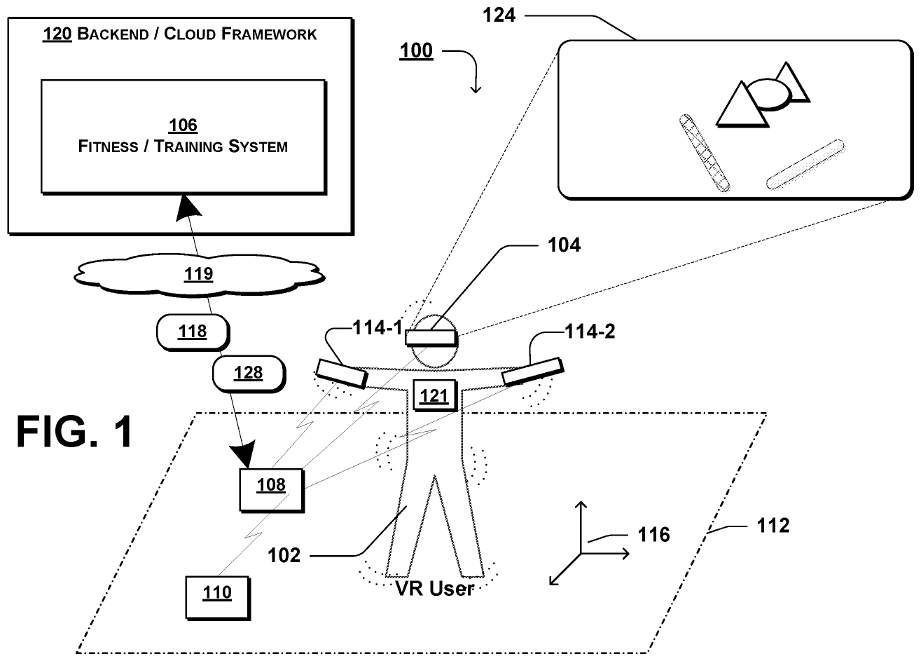

A system supporting a real-time virtual reality (VR) environment 100 for a virtual and augmented reality fitness training system is described now with reference to FIG. 1, in which a person (VR user) 102 in a real-world environment or space 112 uses a VR device or headset 104 to view and interact with and within a virtual environment. The VR headset 104 may be connected (wired and/or wirelessly) to a training system 106, e.g., via an access point 108 (e.g., a Wi-Fi access point or the like). Since the user's activity may include a lot of movement, the VR headset 104 is preferably wirelessly connected to the access point 108. In some cases, the VR headset 104 may connect to the training system 106 via a user device or computer system (not shown). While shown as a separate component, in some embodiments, the access point 108 may be incorporated into the VR headset 104.

Sensors (not shown in the drawings) in the VR headset 104 and/or other sensors 110 in the user's environment may track the VR user's actual movements (e.g., head movements, etc.) and other information. The VR headset 104 preferably provides user tracking without external sensors. In a presently preferred implementation, the VR headset 104 is an Oculus Quest headset made by Facebook Technologies, LLC.

Tracking or telemetry data from the VR headset 104 may be provided in real-time (as all or part of data 118) to the training system 106.

Similarly, data from the sensor(s) 110 may also be provided to the training system 106 (e.g., via the access point 108).

The user 102 preferably has one or two handheld devices 114-1, 114-2 (collectively handheld device(s) and/or controller(s) 114) (e.g., Oculus Touch Controllers). Hand movement information and/or control information from the handheld controller(s) 114 may be provided with the data 118 to the training system 106 (e.g., via the access point 108).

In some embodiments, hand movement information and/or control information from the handheld controller(s) 114 may be provided to the VR headset 104 or to another computing device which may then provide that information to the training system 106. In such cases, the handheld controller(s) 114 may communicate wirelessly with the VR headset 104.

In some embodiments, at least some of a user's hand movement information may be determined by tracking one or both of the user's hands (e.g., if the user does not have a handheld controller 114 on/in one or both of their hands, then the controller-free hand(s) may be tracked directly, e.g., using 3D tracking).

Although described here as using one or two handheld controllers 114, those of skill in the art will understand, upon reading this description, that a user may have no handheld controllers or may have only one. Furthermore, even when a user has a handheld controller in/on their hand, that hand may also (or instead) be tracked directly.

The VR headset 104 presents the VR user 102 with a view 124 corresponding to that VR user's virtual or augmented environment.

Preferably, the view 124 of the VR user's virtual environment is shown as if seen from the location, perspective, and orientation of the VR user 102. The VR user's view 124 may be provided as a VR view or as an augmented view (e.g., an AR view).

In some embodiments, the user 102 may perform an activity such as an exercise routine or a game or the like in the VR user's virtual environment. The training system 106 may provide exercise routine information to the VR headset 104. In presently preferred embodiments, the activity system 126 may provide so-called beat-map and/or other information 128 to the headset (e.g., via the network 119 and the access point 108).

As the user progresses through an activity such as an exercise routine, the VR headset 104 may store information about the position and orientation of VR headset 104 and of the controllers 114 for the user's left and right hands.

In a present implementation, the user's activity (and a beat-map) is divided into sections (e.g., 20 second sections), and the information is collected and stored at a high frequency (e.g., 72 Hz) within a section. The VR headset 104 may also store information about the location of targets, portals and all objects that are temporally variant, where they are in the 3-D space, whether any have been hit, etc. at the same or similar frequency. This collected information allows the fitness system to evaluate and/or recreate a scene at any moment in time in the space of that section.

Collected information may then be sent to the training system 106, preferably in real-time, as all or part of data 118, as the user's activity/workout continues, and several of these sections may be sent to the training system 106 over the course of an activity/workout. The data 118 that are provided to the training system 106 preferably include beat-map information.

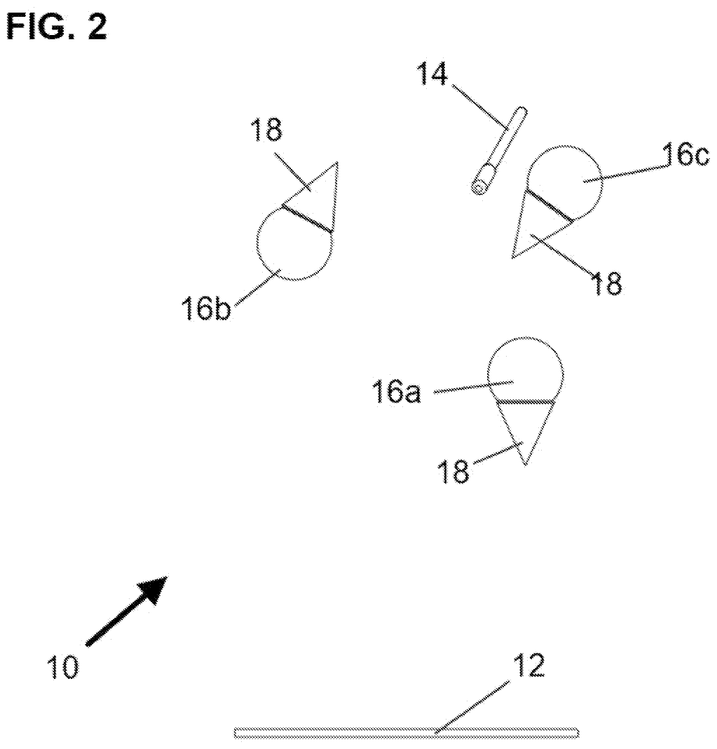

Continuing with this example, in the fitness game called Supernatural, the player is meant to remain at a fixed location in the real world during gameplay so that their VR presence remains at a central point within the VR environment. Referring to FIG. 2, an exemplary VR environment 10 is shown including a virtual graphic image of a platform 12. Platform 12 may be generated and displayed within the VR environment to help orient the player as they play this game. It further provides a “safe” playing area for the player, since its location was established prior to starting the game to be free from any obstacles located in the real world. This allows the player to feel comfortable playing the game at full intensity, with full freedom of movement and without fear of hitting any real objects in the real world. Applicants contend that the freedom of movement provided by platform 12 may help the player reach flow-state when playing a game, by helping to separate the player from the real world and further immerse them into the virtual one. The player remains at the location of platform 12 and may be provided with a graphic-generated baton 14. The player in this particular workout game will be able to view the environment scene, platform 12, hand controllers (not shown in the figures) and baton 14. Usually, two batons are provided, one for each hand, but only a single baton is shown in the figures for clarity. The concept of the present inventive technology may be applied to one or more moving objects or action sequences, including the use of one, two or more batons. Baton 14 may be graphically generated to appear and move in relation to the player's hand, as determined by the orientation and location of the handheld VR controller, The player will be able see the graphically-generated baton using the VR headset, being held by their graphically-generated hand. Baton 14 will move in exact response to the movement of the player's actual right hand in the real world, as is understood by those skilled in the art. The length and shape of baton 14 is known by the software program so that its exact location, orientation and movement speed in the virtual world is also known by the software program. The end result is that the player sees a virtual world in their own eyes, and in that world, it appears to the player that they are holding a baton 14. The player may be presented with imagery that makes them feel like they are present and functioning in a virtual world. According to exemplary embodiments hereof, the player may swing baton 14 within the VR environment so that a predetermined point along baton 14 follows a path which may be accurately measured at any time, and for any length of time. As described in greater detail below, the player will use virtual baton 14 to virtually hit virtual objects being projected from a distant virtual location. The objects are carefully choreographed to sync with the beat of music being played during the game so that when the objects reach the virtual location of the player, as indicated by the location of baton 14 in the VR environment, the player will hit each object to the beat of the played music, similar to beating a drum to the beat of music. The music being played may be selected by the player before the workout game begins. This means that the player is likely familiar with, and likes the type of music they have selected. By allowing the player to select their desired music, the player may be offered auditory familiarity when playing the workout game. They become comfortable in their virtual environment, which encourages the player to focus on the rules of the game (which, in the case of Supernatural, includes the rule to correctly hit passing objects). By playing known music, the player may relax and may be more likely to improve performance and reach a flow-state. According to exemplary embodiments hereof, overtime, as a player plays a game, the present system may keep a record of which specific track of music, which specific song, which artist, or which type of music best encourages the player to reach a flow-state. This process may be AI driven to automatically select music from the player's personal music streaming service and also provide a matching beat-map (the beat-map provides objects that are synchronized to the selected music) based on the player's past flow-state performance and history. This arrangement will allow a player to consistently reach a flow-state while playing the selected workout game which matches their favorite selected music.

During gameplay of the Supernatural game, which is being used to illustrate exemplary embodiments hereof, graphically generated spherical objects 16a, 16b and 16c are selectively generated by the software program to appear at a certain distant virtual location within the VR environment. In this example, the generated objects are sequentially projected towards the player's central location, platform 12 from the distant virtual location.

During the course of a “workout” in this exemplary game, a multitude of objects 16 will be hurled towards the player in a predictive and known manner by the system, but not necessarily known to the player. For clarity, only three objects 16a-16c are being shown in this example to illustrate the present inventive technology. To add complexity and interest to this particular exemplary game, objects 16a-16c each include a corresponding hit-direction identifier 18a-18c (in the form of a cone structure pointing like an arrow in a predefined direction), attached to each respective sphere. The direction of each hit-direction identifier 18a-18c, for each object 16a-16c, indicates to the player the direction the player must swing baton 14 to correctly hit the particular object 16a-16c, as the particular object moves past the player's location. As objects 16a-16c individually reach platform 12, the player will swing virtual baton 14 (by swinging their real arm in the real world) so that the baton hits the particular object 16a-16c, in the correct direction of hit, as indicated by the direction of each respective hit-direction identifier 18a-18c. If the player succeeds at swinging baton 14 correctly and hits object 16a-16c in the correct direction, as indicated by the respective hit-direction indicator 18a-18c, for the particular hit object, the system will effectively register a “hit” point to the player, which will be added to the player's eventual score, or performance metrics.

An aspect of this particular game is such that regardless of whether or not the player successfully hits an object 16a-16c, additional objects will continue on their respective path towards the player's central location, without stopping until the game ends. As objects 16a-16c advance towards the player, they will appear to the player as the image shown in FIG. 2. This image represents a still-frame snap-shot view in gameplay time and, of course, will change constantly as more objects (not shown) are introduced during the game, at different relative positions within the environment, and also in the field of view of the player.

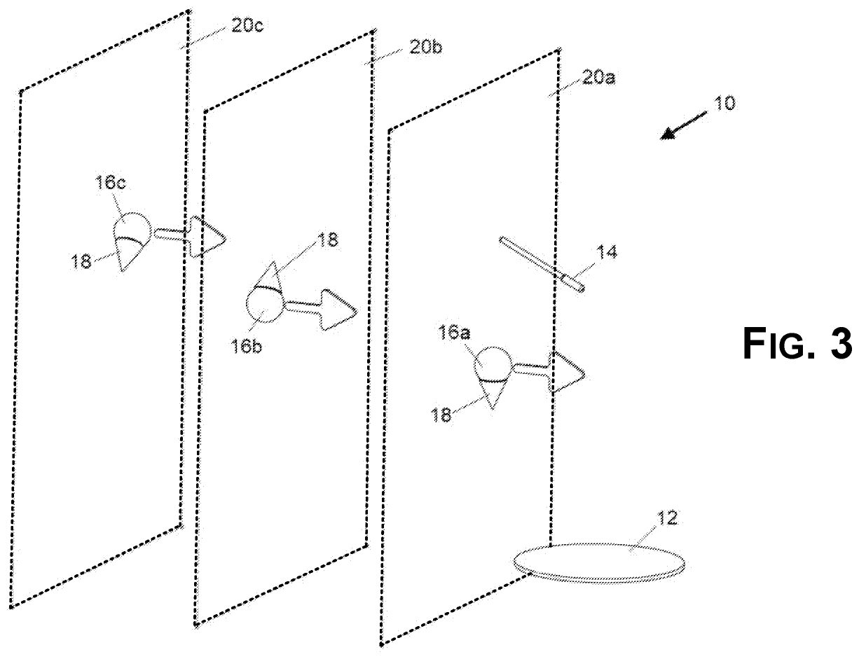

As shown in the perspective view of FIG. 3, and according to this particular exemplary game, each object 16a-16c is spaced from each other, and spaced from the player, at varying distances, illustrated by imaginary planes 20a-20c, wherein object 16a is located within plane 20a, closest to the player at platform 12, and baton 14. Object 16b is located in plane 20b, and object 16c is located in plane 20c. As objects 16a-16c advance towards and arrive at the player at platform 12, the player should hit each object in the correct direction, as indicated by the respective hit-indicators 18a-18c, and in the order that objects 16a-16c arrive at platform 12 (plane 20a).

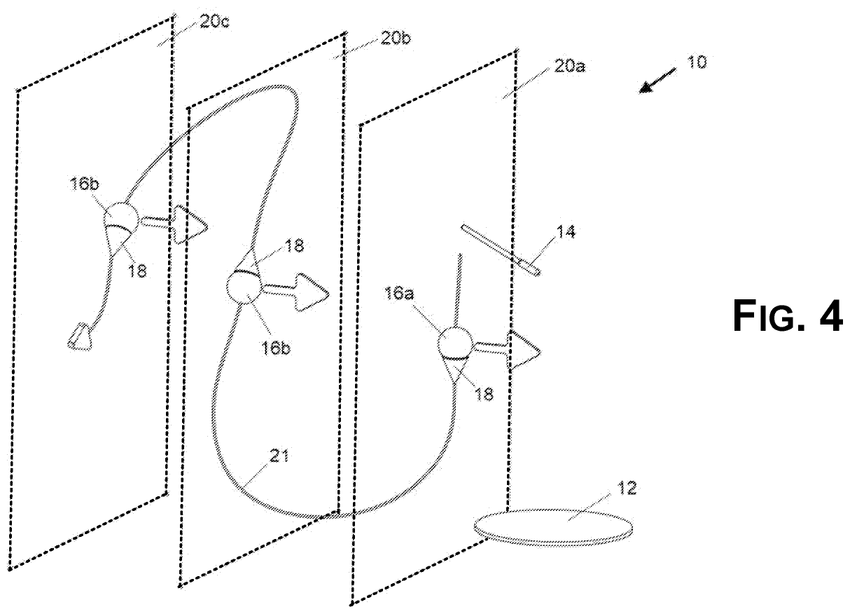

Referring to FIG. 4, according to one or more exemplary embodiments hereof, the computer system running an appropriate software program may be used to calculate and record an “ideal player response path” 21 for each game session or a portion thereof, or for a select combination of projected objects 16a-16c during a game session. The ideal player response path 21 may be determined prior to playing the game. The ideal player response path 21 may be calculated automatically based on a predetermined set of rules which will vary depending on the type of game being played. For this exemplary

Supernatural workout game being described to illustrate the present technology, the rules to calculate an ideal player response path may include some or all of the following information regarding the objects being graphically projected towards the baton-wielding player:
a) The hit-directions 18a-18c of each projected object 16a-16c;
b) The projected speed of each object;
c) The relative position of each object, with respect to the player's baton;
d) The total number of objects;
e) The distance between objects;
f) The size of each object; and
g) The size and shape of the baton.

The resulting ideal player response path generated by the computer system and software in this example, represents an “ideal” or “optimal” path along which a representative point of the graphically-generated baton 14 must follow in the VR environment to correctly hit all projected objects 16a-16c, in the most efficient manner (or the “best” manner according to the particular rules of the game). For this example, the term “efficient” is meant to represent a fluidity or smoothness of a player's baton movements, since this particular and exemplary game relies on baton movements to play.

It should be noted that the ideal player response path along which baton 14 should follow during an “ideal” (or perfectly-played) game is not confined to a single plane since the full range of the player's baton movement about their body during gameplay is defined by an irregular three-dimensional space, and will vary depending on the player's body size and arm length. The VR system (computer system) and the exemplary Supernatural software program is capable of tracking the exact location and movement of the player's hand and any held virtual object, including baton 14 and is therefore capable of recording the actual player response path 22 of baton 14 during the game. As described below, the recorded actual player response path 22 may then be compared with the ideal player response path to determine a percentage of path-alignment during which the two paths coincide.

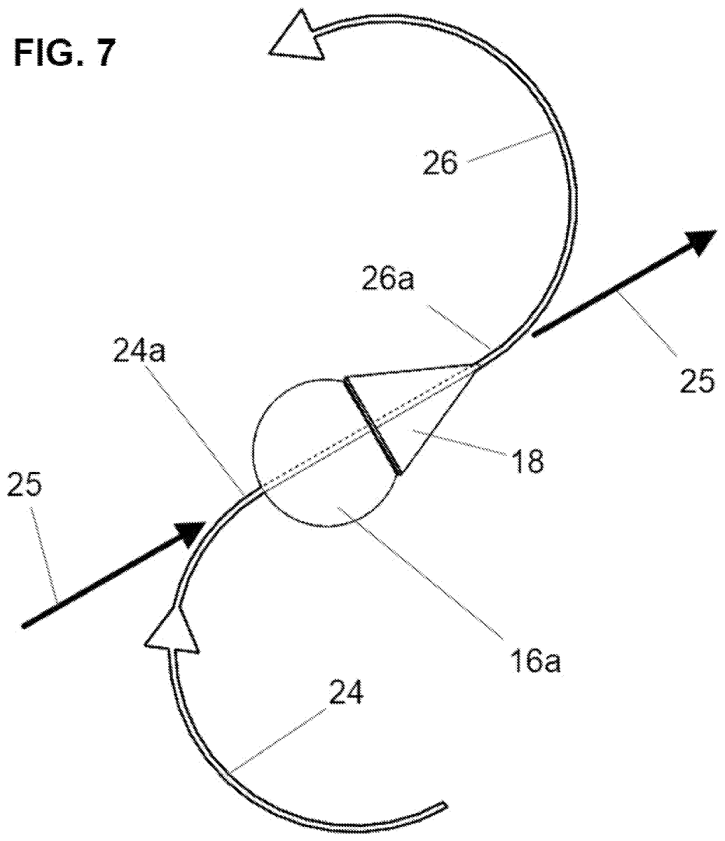

In this exemplary game, if the player moves their baton 14 along the ideal player response path, as they play the game, they will not only have correctly hit each object at the correct time in the VR space and along the correct hit direction, but also, and perhaps more importantly, achieved the highest level of fluidity of motion possible as the player moves their baton between objects. As shown in FIGS. 4 and 7, an exemplary ideal player response path 21, based on the above-listed rules and also based on this exemplary game, will likely include a smooth and short arc 24 approaching the next object 16a to be hit. The advancing end 24a of arc 24 is tangent to the proper hit-direction 18 of the object, as indicated by arrows 25, in FIG. 7. Similarly, the path of baton 14 exiting a now hit object 16a will likely be a smooth and short arc 26, whose exiting end 26a is tangent to the hit direction 18 of the previous hit object.

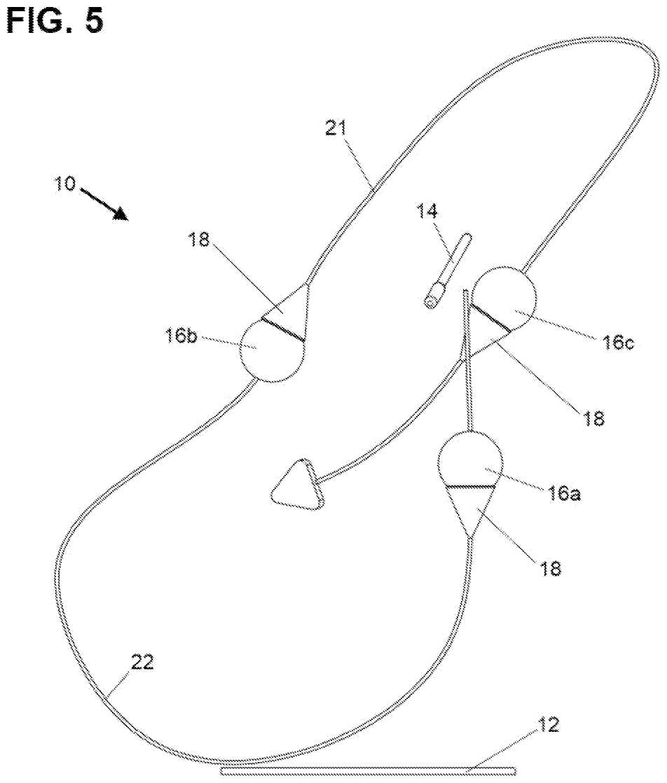

The ideal player response path indicates a path of smooth gameplay. According to exemplary embodiments hereof, the closer, and the more smoothly the player moves baton 14 along the ideal player response path for any particular workout session, the closer that player may be to reaching a flow-state. It should be noted that the ideal player response path 21, shown in FIG. 4, is shown spread out across the three planes 20a-20c to illustrate how the hit-path intersects each object over time, but the actual movement of baton 14 will remain generally adjacent to the single and closest plane 20a, and such baton movement will resemble the ideal player response path 21 shown in FIG. 5, intersecting each advancing object as each object moves close to plane 20a.

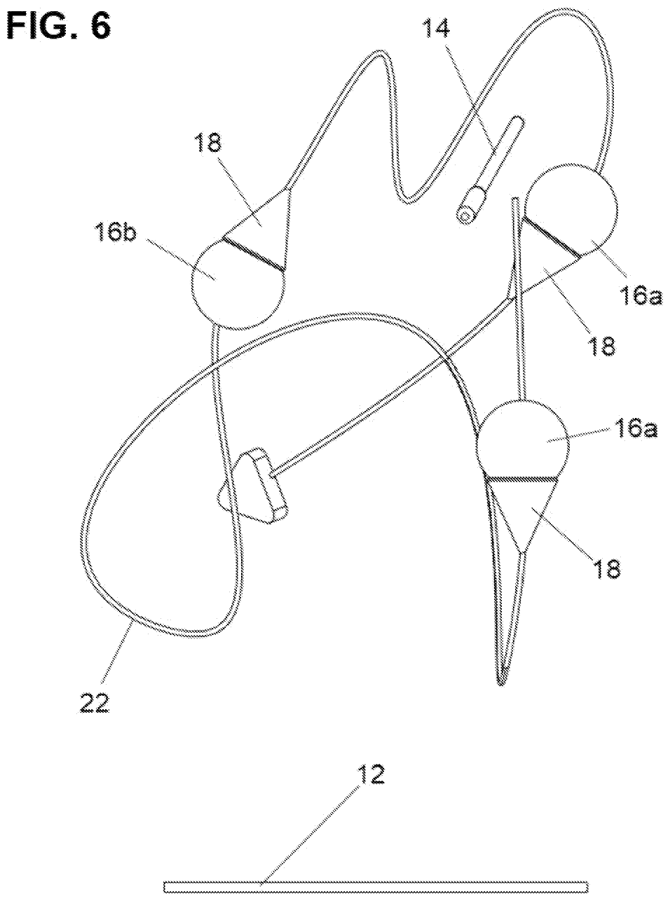

The player will swing baton 14 around in order to hit each object 16a-16c correctly, as each object passes by the player's central location in the virtual world. The baton will follow a unique path, hereinafter referred to as the actual player response path 22, which is illustrated in FIG. 6. As described in greater detail below, and according to exemplary embodiments hereof, actual player response path 22 may be stored in memory within the computer system (i.e., the VR system) and may be used to determine if the player has reached a certain level of performance, and possibly a flow-state, as described in greater detail below.

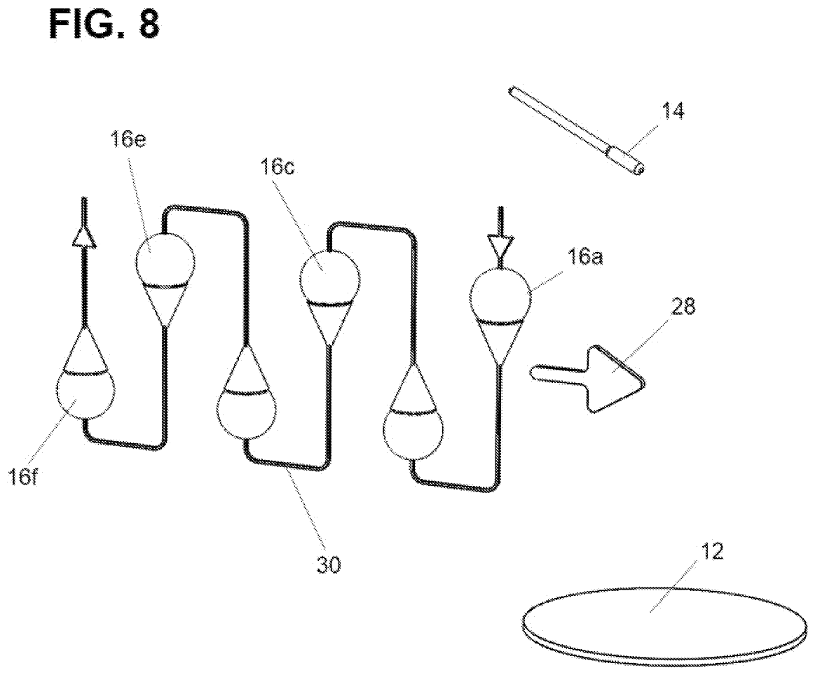

This particular “Supernatural” game, described as an example of the present technology, relies on smooth and fluid motion of the player as they try to direct their baton 14 gracefully along the ideal player response path. However, smooth and fluid movements are not a requirement of the embodiments hereof and do not necessarily indicate that the player has reached a flow-state. The present exemplary game or other types of games may yield an ideal player response path that follows a more jerky and rapid back and forth, or up and down baton movements, similar perhaps to a drummer hitting a drum with the baton. This is illustrated in FIG. 8, wherein a perspective third person view of a series of objects 16a-16f are advancing towards a player (not shown) located at platform 12 in the direction of arrow 28, and baton 14. In this example, owing to the rapid succession of objects having alternating hit directions, the ideal player response path 30 will force the player to generate quick, perhaps jerky, up and down movements. Even though this arrangement of objects being projected towards the player forces the player to respond in a quick and jerky manner, if the player's baton closely follows the ideal player response path, however irregular that particular path may be, Applicant's contend that there is a high probability that the player is either in a flow-state, or on the verge of entering one. Also, adding a variety of types of ideal response paths to a workout session or game is often desirable to break up otherwise repeating and easily learned, more fluid response paths. Adding a response path that is more “staccato” and jerky offers a player a sudden change or variant of response which may be challenging. This keeps the player alert and, in some cases, such surprise challenges of increased difficulty may push a player into a flow-state, if they are not already in one.

As mentioned above, just because a player is playing a game well, as defined by closely following ideal actions during gameplay, such as moving baton 14 along ideal player response path 30, does not mean that the player is playing in a flow-state. The fact that a player closely following an ideal player response path (or some other ideal response) for a period of time during a particular game may suggest that a flow-state has been reached, but secondary factors may be considered, as a form of supplemental evaluation, to achieve a higher level of confidence that the player is truly in such a flow-state. For example, secondary factors may include performance metrics, such as number of successful and sequential runs of hits and/or misses of targets, difficulty of select portions of the game, and how long the player plays the particular game. The secondary factors may also include various biometrics of the player which may be measured, either continuously during gameplay, or only when the computer system (the VR headset components and the running game software program) detects that the player's actual movements during the game match a predetermined ideal response for a period of time. Such biometrics include breathing rate, heart rate, body temperature, eye-movement, head-movement, body-movement, and detected speech, or detected silence. For example, if a player's actual response to a particular section of a game closely matches (within a predetermined margin) an ideal response, the system may then measure the player's eye-movement and heart rate to determine that, in this example, a flow-state has been reached. If biometrics are to be used, various sensors will have to be integrated into the VR hardware and/or otherwise connected to the player's body. For example, eye-tracking will require that the VR headset being used includes eye-tracking cameras and also an accompanying processing software. Head-movement is already detectable using the inertial movement unit, which is part of any conventional current VR headset.

A separate device, such as an Apple Watch, made by Apple, Inc., of Cupertino, CA, may be worn on the player's wrist and may provide, to the computer system, heart rate information of the player in real time as the player plays the particular game. If such biometrics are used to help confirm that a player has indeed reached a flow-state during gameplay, the biometrics will have to be calibrated for each particular player so that the present system may establish a baseline response for each particular biometric. For example, the system must understand how the heart rate of a particular player's heart will respond at different times during a game, including when the player has achieved a flow-state (as suggested when the player's responses during gameplay match closely with ideal responses), and also when a player is playing poorly, and perhaps even panicking. The baseline biometric data may be automatically obtained and updated for each player over time by recording and storing such biometrics at different times during a workout (at the beginning, during the middle and during the cooldown period) to determine biometric recovery data-how quickly does the player's heart rate recover. The stored information may be adjusted and averaged over several workout sessions to offer more accurate data. Once the baseline is established, monitored heart rate data may meaningfully supplement other indicators to more accurately determine if a flow-state has been reached, and if so, to what level.

The biometrics of a player may be measured or monitored using conventional sensors, including but not limited to pressure sensors, heart rate monitors, thermometers, inertial motions sensors, radar, and optics.

To further help determine if a player has reached a flow-state, characteristics may be detected and considered which indicate that a flow-state has not been reached. For example, and according to exemplary embodiments hereof, if baton 14 is being moved about within the virtual environment so that it generally follows the predetermined ideal response path 21, but the system detects very small (micro) and quick movements of baton 14, then it may be likely that that the player is not in a flow-state. In this example, the detected micro-movements indicate panic-adjustments by the player and therefore also may indicate a lack of confidence in the player's movements. Jerky movements may be permitted when in a flow-state, but only when the ideal response path requires them. Players that achieve a flow-state are confident in their actions during gameplay.

Similar to how quick and jerky hand movements that a player may use during gameplay may indicate that a player has not yet reached a flow-state, another secondary factor to consider is jerky hand movement synchronized with quick eye-movement. When this happens, the player's eyes are forced to focus on each object before allowing their hand to follow through with a swing to hit the object. We have recognized that when a player has reached a flow-state, their eyes become settled and tend to focus at a point in the distance. The player's swinging action at passing objects may be performed in the player's peripheral vision. The player in a flow-state tends not to focus on a nearby object they are hitting, in the Supernatural example above, or generally at actions the player must take during gameplay. In a flow-state, a player's eye-movement becomes less pronounced and the player tends to trust the actions of their hand and arm movements to carry out whatever action may be required, using only their peripheral view. Similarly, the player's head movement may be monitored during gameplay to determine if the player is glancing down at their virtual hands. If so, this would be an indication that the player has not reached a flow-state.

According to exemplary embodiments hereof, we further contemplate the present computer system measuring the movements of the player's facial muscles during gameplay to help determine if the player is in a flow-state. Appropriate motion sensors may be installed within the VR headset so that the sensors contact the player's cheeks. The sensors would measure minute movements of the player's facial muscles during gameplay.

Other secondary factors of a player to determine if a player has reached a flow-state include tensing of a player's muscles, such as their abdominal muscles, or their neck and leg muscles. A player in a flow-state will show little muscle tension in their body and will be in a relaxed state of mind and body.

Foot movement by a player may also be used to help determine if they have reached a flow-state. If the particular game being played requires only upper-body movement to play and the player shows regular and/or sudden adjustments of their feet, or a single foot, it is likely that the player has not reached a flow-state since such foot repositioning is usually performed by a person in an effort to maintain balance due to sudden core movements. An imbalanced player implies that the player is unsure of their movements and perhaps even panicking during gameplay. The player must make sudden core movements to struggle to meet the game's challenges and remain following the ideal response path, and must make quick foot movements to maintain balance. Motion sensors, such as inertial movement units, described above, may be used to detect movement of the player's feet, or core.

According to exemplary embodiments hereof, the system's predetermined ideal player-response path may include a response path for each of several player movements, including, in this Supernatural example, an ideal response path for baton 14 (by sensing the player's hand movements using controllers), for the player's eyes, using conventional eye-tracking technology, for the player's feet, using separate motion sensors positioned on the player's feet and/or legs, and other parts of the player's body. In other words, for a “perfect” game to be played, a player may be required to move several parts of their body a predetermined way and this may be measured with appropriate sensors. For example, if the player moves baton 14 “perfectly,” following the “perfect” path (as defined by the ideal person-response path), and also follows the “perfect” eye-movement path, (by not moving their eyes to focus on each passing object, then that player is likely in a flow-state, and this may be quantitatively measured by comparing the ideal path data with the actual path data.

As mentioned above, a typical VR headset and hand-controllers include inertial sensors which allow the system to establish orientation, position and movement information of each component very accurately. According to exemplary embodiments hereof, these sensors located in the hand controllers and headset may be used to detect movement of the player's feet as well, without requiring dedicated foot-movement sensors. A player wearing the hand controllers and headset may follow a prescribed calibration movement prior to playing the game. The calibration process will instruct the player to move their hands, head, feet and other body parts in various directions, orientations, and speeds. The sensors located in the headset and hand controllers will then record and store the movement signals each detects to create a signature movement signal that represents the player moving a specific body part, such as a foot. During gameplay, if the player moves their foot, the movement detected by the handset and hand controllers will match the stored signature movement, indicating to the system that the player's foot moved.

Another secondary factor in determining if a player has reached a flow-state, or is close to reaching a flow-state is if the player performs a jump with excitement, or shouts out an audible exclamation, such as “Woo Hoo!” “Let's do this!”, or similar words or sounds). Such audible information may be picked up by a microphone, which is standard in current VR headsets, including the above-identified Quest 2 by Facebook's Oculus brand and compared with known stored sounds to help determine if the player is happy and excited, or upset and frustrated. If a player shouts out exclamations of frustration, such as swearing or negative grunt sounds, then the player is likely frustrated and not in or near a flow-state. In contrast, happy sounds, such as “Woo Hoo!” indicate a possible flow-state condition.

The game example described in great detail above, and illustrated in the figures illustrates just one type of virtual reality game with which the present technology may be used. There are many different types of games currently available for various formats, such as personal computers (PC), Sony's PlayStation, virtual reality (VR) and handheld units, such as Nintendo's Switch, and Apple's iPad. The present technology, described herein is likely more functional and more accurate when applied to games wherein a defined ideal player-response may be established for at least a portion of the game. These games are typically of the type wherein the player plays from a set location and various interactions are sent to that set location. With these types of games, ideal player response signatures may be easily calculated before a game is played and then used to compare with the player's actual response signature during gameplay. More complicated games, such as first person shooter games may be more difficult to determine an ideal player response for long periods of time, owing to the variability throughout the game. For example, in a first person shooter game, a player's actions or responses continuously affect and change the future interactions later in the game. If a player shoots at an enemy and misses, that enemy is now “live” to be a threat later in the game. However, in such games with multiple overlapping scenarios and disrupted or unpredictable events, the present technology may still be applied, but requires determining shorter moments of predictable ideal player responses, perhaps just a few seconds long when a player shoots at and hits a target, and then does it again a few seconds later. If the player is in a flow-state, it may only be detectable during short repeating intervals during which the player's responses do match ideal responses for those short durations. The present system will detect and record those moments during which a player's responses align with ideal or predicted responses during the game and use this information to estimate a level of flow-state, or at least an estimate of a percentage of time a flow-state was achieved during the game (or a predetermined thereof). We contemplate that different sections of the game, during which a player's actual actions match predetermined ideal actions, may be weighted differently, depending on a predetermined level of complexity or difficulty at that section of the game.

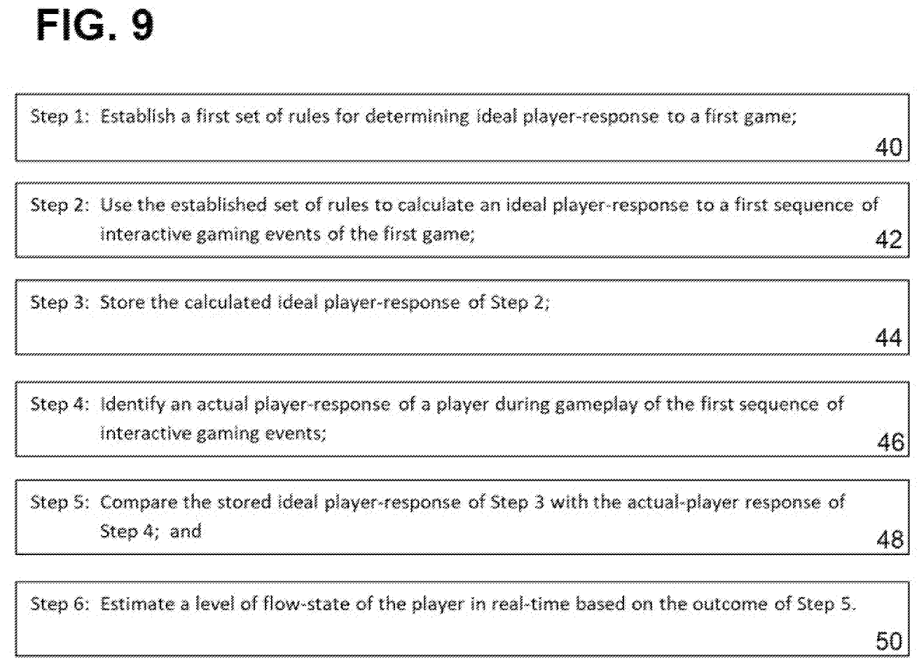

Referring now to FIG. 9, the present system follows a presently preferred set of exemplary actions to establish a level of flow-state by a player playing a particular game. First (at 40), a set of rules is established to determine an ideal player-response 21 for a particular game, or part of a particular game. For example, referring to FIG. 7, and the Supernatural game example described above, an object 16a includes a corresponding hit-direction indicator 18a, whose direction indicates the direction a player's baton 14 should pass when hitting the particular object. These conditions make up the rules for determining an ideal player-response 21 in that the baton's movement must end up tangent to the hit direction (arrow 25, in FIG. 7) when the baton arrives at object 16a. Continuing reference to FIG. 9, (at 42), the present system uses the established rules of the first step 40, and calculates an ideal player-response 21 to a first sequence of interactive gaming events of the particular game. Next (at 44), the calculated ideal player response 21 may be stored in local electronic memory, as understood by those of skill in the art.

Next (at 46), the present system monitors the actions of the player playing the particular game and identifies the player's actual player-response 22 to the first sequence of interactive gaming events. For 3-D games which are designed to play using a virtual reality headset, the present system is able to automatically determine the exact spatial location of any graphically generated reference point, such as any point along baton 14, within the virtual world. When a player reaches a flow-state, the player becomes extremely focused, but certain distractions may cause the player to leave the flow-state condition. Maintaining a flow-state using a VR headset may perhaps be a bit easier than other formats of games since the nature of the VR headset and other VR gear uniquely isolates users more than other computer-based interactive experiences. The player playing a VR game quickly becomes immersed in the virtual world, and literally blocks out any view of the real world. This isolation encourages the player to become focused on the game itself. For other types of non-VR games, such as games that have a display and a controller, the ideal player response may not necessarily be in the form of a “path,” or baton movement, but could be represented by a select sequence of controller operations, such as a specific sequence of movements of a joystick, or depressing specific buttons in a specific “ideal” order.

Continuing with the exemplary flow shown in FIG. 9, next (at 48), the system compares the actual player-response 22 (of step 4) with the ideal player response 21 (of step 3) of the first sequence of interactive gaming events. This may be performed, e.g., mathematically, by comparing the virtual location in 3-D space of each point of the player's actual response path with the same point along the ideal response path, and calculating the absolute distance between the two points. A controllable and variable margin of error for each point-comparison may be established to generate a running average along a predetermined section of response path.

Finally (at 50), the present system estimates a level of flow-state of the player based on how closely the player's actual response 22 matches the ideal player response 21. If the player maintains a distance from the ideal response path without exceeding a predetermined threshold value for the predetermined section of response path, then the average of the measured values may be used to determine if a flow-state has been reached.

According to the exemplary embodiments hereof, a flow-state is reachable for many different types of games and computer-generated activities, as long as an ideal player-response may be established. A flow-state is more easily reachable when playing games or computer activities which require a high-level of player movements, such as a fitness game or a first-person shooter game. However, Applicants suggest that even less-active and quieter computer games and computer-generated game activities, such as yoga, stretching and meditation may also include an ideal player-response, but the response will be directed to other measurable factors besides movement. Instead of an ideal player response that involves a specific baton-hit sequence, as described in the above example of the Supernatural fitness game, a meditation activity may require an ideal player-response that tracks controlled breathing and controlled motionlessness of the player. Other appropriate biometrics of the player may also be tracked, depending on the particular gaming activity. If, during meditation, for example, the player appears relaxed, with no measurable muscle movements, but has a heart rate that is higher than “ideal”, then that player's actual-response will not match the ideal player-response, since the ideal player-response includes a certain heart rate range. Also, the present system may generate not only an ideal-player response, but also an ideal playing environment, such as ambient lighting, music type, etc. This would be more applicable to non-VR games where the player's eyes are not covered by a VR headset and they may see ambient light during gameplay.

### When a Flow-State is Reached:

When the present system determines that there is a high-likelihood that a player is playing in a flow-state, we recognize the need to maintain this state for an extended period of time. The longer a player enjoys playing a game while in a flow-state, the higher the chance that the player is satisfied and will return to play the game again, or play the same game for a longer period of time. The more times a player plays a particular game, the higher the potential revenue the game will yield. The challenge resides in providing a helpful change during detection of a flow-state, or during the detection of a decline in flow state, that will encourage continuance of the flow-state by the player without causing a disruption, in which case the player may prematurely withdraw from the meditative state.

According to exemplary embodiments hereof, when the present system determines that a player is likely experiencing a flow-state, while playing a game (or otherwise interacting with an audio/visual computer-controlled experience), any of several characteristics that define the audio and/or video being played during the game, workout, or experience may be adjusted gradually. Once a player is in the “zone,” it may be desirable to mitigate or eliminate any distractions, be it audio-based, or video-based, but it is important to make adjustments gradually, to avoid becoming a distraction in itself. For example, during the above-described exemplary Supernatural game, objects 16a-16c are actually projected towards platform 12 following a beat-map, wherein objects 16a-16c are hurled at the player so that they precisely arrive at the location of the baton 14 in sync with the beat of the music being played. According to exemplary embodiments hereof, during a flow-state, the volume of the song being played may be gradually increased to help immerse the player into the moment, or gradually decrease to help eliminate possible distraction. At the same time, the volume of any coaching voice, which normally advises the player how to play better, will gradually attenuate. Alternatively, or in addition to, a particular track or portion of the song may be seamlessly repeated during a detected flow-state (a kind of on-the-fly remix of the song), together with a repeat of the sequence of objects reaching the player so that the song continues to match the beat-map of the objects. By doing this, the player may extend their flow-state experience by simply repeating the original visual and audio experience that triggered the flow-state initially. This latter technique will likely only be able to be used once or twice to extend the flow-state of the player since the player will quickly detect a repeat arrangement and likely fall out of the flow-state. However, according to exemplary embodiments hereof, the system may present to the player any of several repeating track patterns with matching beat-maps of projected objects that are similar to the ones that the player is enjoying in their flow-state thereby encouraging the player to extend their flow-state without detecting a repeating pattern of objects and/or beats. Furthermore, according to another one embodiment of the present technology, the system may detect if a song or other music being played (while a player of the game is in a flow-state) is about to end, or includes a sudden change in tempo, beat, harmony or intensity (any noticeable characteristic change) which may cause the player to affect their flow-state condition. When detecting these scenarios, the system may automatically and seamlessly remix the currently played song or music with a supporting section of the same music or same type of music, or a different song or track, but with common sound characteristics so that the player is encouraged and content to continue with playing the game within a flow-state. Other replacement music or songs may be generic with repeatable tracks, and/or may be sourced from a specifically “flow-tuned” track list with or without lyrics, which are specifically curated to preserve and extend a flow-state for the particular player.

As mentioned above, the exemplary Supernatural game introduces a VR environment image in which the player resides during gameplay. If it is determined that the player has reached a flow-state during gameplay, the environment image (or any given background image or an individual element or feature within that image) may be altered, again, preferably gradually, according to exemplary embodiments hereof, so that the image detail is decreased or otherwise blurred. Alternatively, or additionally, the colors of the background image may be changed to be less vibrant and more neutral (e.g., gray, brown, or other earth tones). The background image (or select portions of the image) is also made to gradually transition from full 3-D color to a line-drawing or sketch image, or provided with a neon effect. Also, all or parts of the background image may transition to pulsate to the beat of the music. Applicants contend that by effectively blurring the surrounding background or environment image, or applying any of the above-identified effects, the player will be encouraged to maintain or even enhance their focus on the game objectives, such as, in the case of the Supernatural game, properly hitting all objects being projected towards baton 14, and thereby maintain their flow-state condition. Also, the illumination of the background image may be darkened (gradually) to lessen potential distractions residing in the player's field of view, and any numbers or text normally being displayed within the player's field of view may gradually be faded as well. Another technique to encourage a flow-state to continue is for the system to introduce a vignette effect on the virtual graphics to promote the player to focus on the projected objects and thereby maintain a flow-state.

According to exemplary embodiments hereof, another technique to prolong a flow-state of a player (once a flow-state has been reached) is to change aspects of gameplay. By quickly introducing either more challenging aspects or easier aspects to the workout or game, a player in flow-state is more likely to remain in that state. For example, in the above-identified Supernatural game, it is critical that each object 16a-16c be hit at a precise moment in time and in the proper direction, as instructed by the hit-direction indicator 18a-18c. According to exemplary embodiments hereof, once a player reaches a flow-state, the tolerance of precision (level of forgiveness) required during gameplay may be adjusted, making it either easier to hit the passing objects, or alternatively, making it more difficult. Also, the speed of the advancing objects 16a-16c, along with the beat of the music may be increased or decreased. Applicants have recognized that the specific aspect that is changed during gameplay is less important than the fact that a change is being made. The change provides a new challenge to the player, and it is the introduction of the challenge that keeps a player retained in a flow-state.

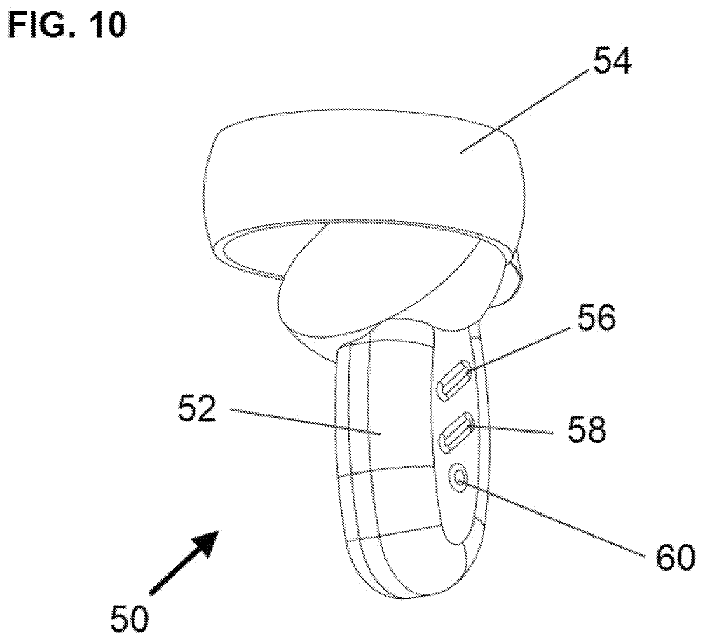

Referring now to FIG. 10, a controller 50 is shown, according to exemplary embodiments hereof. Controller 50 includes a handle 52, and an IR communication ring 54. In use, the player grips handle 52 during gameplay and, as they move controller 50 around, as required during gameplay, IR communication ring 54 communicates with the VR headset (not shown). This IR communication with the headset informs the VR system the exact location and orientation of the controller. According to exemplary embodiments hereof, handle 52 includes a skin-temperature sensor 56 and a sweat detection sensor 58. Measuring a player's skin temperature and level of sweat on a player's hands during gameplay offer secondary factor data which may help determine if the player is playing in a flow-state. Also included within handle 52 of controller 50, according to exemplary embodiments hereof, is a pressure sensor 60 which will measure how firmly the player holds handle 52 during gameplay. How tight the player holds controller 50 during gameplay may also help establish if the player is playing in a flow-state. During flow-state, a player's grip will likely be relatively light. If a player is having trouble concentrating, and not in a flow-state, they will likely tighten their grip on controller 50.

During gameplay, regardless of whether the player is playing in a flow-state or not, the present system may monitor and record various information, including some or all of the following:
Specific game (virtual world) conditions, including the environment image being displayed, the colors of the environment and objects, the lighting details of both the environment image and the objects and the baton, etc.;
External (real world) conditions, where available, including room temperature, ambient noise level, humidity, barometric pressure, lighting, etc.;
Player biometrics, including heart rate, skin temperature, blood oxygen levels, breath rate, eye-movement, weight, height, etc.

Music related information including genre, artist, song title, sound, such as overtone, timbre, pitch, amplitude, duration, and melody, harmony, rhythm, texture, structure, form, expression, such as tempo, etc.;
Coaching information, if used, including level of instruction, voice, volume, tone, (male/female, etc.); and
External player-considerations (uploaded from the player's smart device or other), including duration and quality of sleep, exercise, and food intake.

The above information may be tracked and stored continuously by the system, and when it is determined that a player reaches a flow-state, the above information may be captured a period of time prior to the determination of reaching a flow-state, during the flow-state, and for a period of time after the player leaves the flow-state. The captured information may be stored by the system for later review and also used to help set future conditions to encourage the player to quickly re-enter a flow-state at a later time. The “period of time” both before and after the flow state is preferably between about 20 seconds and about 4 minutes, but any duration may be useful.

### Reaching a Player in Flow-State:

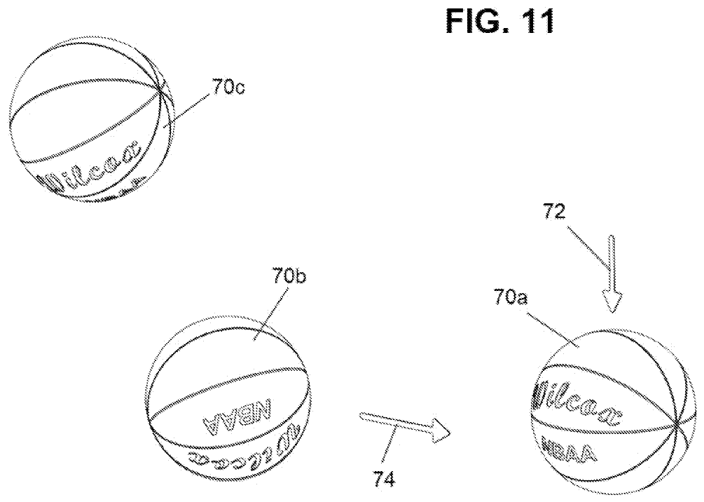

As described above, a person playing a game in a flow-state typically may become fully immersed in their actions and develop a positive feeling of energized focus and satisfaction. According to exemplary embodiments hereof, and referring to FIGS. 3 and 11, previously-described virtual objects 16a-16c, shown in FIG. 3, which are being projected towards the player located at the virtual platform 12 and which include corresponding hit-direction indicators 18a-18c, are gradually, or suddenly graphically transformed into new objects 70a-70c, shown in FIG. 11, which may have a different shape, but are similar in size to virtual objects 16a-16c. In the example shown in FIG. 11, the new shape may be a branded basketball called “Wilcox.” We contend that a person in a flow-state will be more receptive to any newly presented visual information, such as text messages and graphic images which align with a sponsor's product or service campaign, and even including rendered consumer products, or photos thereof.

A person playing a game in a flow-state may enjoy a higher retention ability and will more likely remember the new visual information being presented during gameplay. During this state, a player will reside in a state of achievement and success, which will encourage the player to foster product acceptance and increase purchase intentions. A successful sponsor campaign relies heavily on a high retention rate by a viewing consumer. It is imperative that the consumer remembers the product name or the brand after experiencing the content. If so, the campaign will enjoy a higher degree of success.

By graphically changing each object 16a-16c into a corresponding branded consumer product, such as “Wilcox” brand basketballs, the player, when playing in a flow-state, is more likely to remember the branded object, and will therefore more likely fully absorb the information. Owing to the higher retention rate a player has during a flow-state condition, the more effective the messaging will be during this critical time period.

Although being in a flow-state opens up the possibilities of new sponsorship methods, there is a concern that presenting new objects 70a-70c to a player in a flow-state may push the player out of the state. To help mitigate this separation of the player from their flow-state, and according to exemplary embodiments hereof, the newly present information, such as the exemplary basketballs, are slowly and gradually morphed from objects 16a-16c of FIG. 3, into the basketball objects shown in FIG. 11. The present system will only make this change to objects 16a-16c when a flow-state of the player is detected and confirmed to be steady and prolonged. Should the player fall from their flow-state during or shortly after objects 16a-16c have been transformed into basketballs 70a-70c, the system will recognize this and will quickly return the objects to what they were during the flow-state and encourage the player to return to that state. Also, the transformed object may be made to appear smaller, and therefore harder to hit than the previous original objects 16a-16c which will provide the player with a challenge. Studies have shown that a player in a flow-state desires a new challenge to the gameplay, so newly transformed objects, such as smaller versions of basketballs may provide effective sponsor messages while actually encouraging the player's flow-state to continue.

The basketballs in the example shown in FIG. 11 may not have an overt hit-direction indicator 18a-18c, like objects 16a-16c do in FIG. 3, but the player will rightfully understand that the newly presented objects 70a-70c are meant to be hit based on the orientation of the “Wilcox” brand logo, from the top of the ball to the bottom, as illustrated by the arrow 72 in FIG. 11. The hit-direction will naturally change orientation as the basketballs likewise change orientation, as they move towards the player in the VR environment, as indicated by the arrow 74.

According to exemplary embodiments hereof, other sponsorship or communication techniques are employed within the virtual world to effectively convey a particular brand or service or message to a player enjoying a flow-state condition. One such technique is to blend a message organically into the surrounding environment of the virtual world so that the brand or information being conveyed to a player is more subtle, more subliminal and thereby is less likely to drop the player from their flow-state. An example of this is to provide graphically-generated birds within the virtual scene which fly around the sky as the player plays a particular game. When it is determined that the player is in a flow-state, the birds gracefully transform and fly in formation of a logo of the brand, or whatever relevant graphic or text information is meant to be conveyed to the player. This allows the player to read or view the message more subconsciously, and in a manner that is more likely to maintain the player's flow-state condition. Other techniques could include providing a relatively faint version of the brand or logo or other information within the virtual environment or on a virtual object so that the player again is provided the information more subliminally and not overtly. Ideally, the player leaves the game wanting to purchase a Wilcox-brand basketball, or watch an NBA game on TV.

Furthermore, following with the basketball sponsor example described above, the players batons could also transform to match the particular product or service being showcased, such as a kind of looped netting material (like a basketball net) wherein the player is meant to capture the passing basketball with the net, instead of hitting it with the batons, as before. By transforming both the objects and the handheld objects into a common theme that matches the theme of the particular sponsor or advertisement, the message being conveyed is likely positively reinforced.

### Scoring a Flow State:

We recognize a desire to provide a scoring system to represent how successful the player was at reaching and maintaining a flow-state during any particular gaming session. There are many ways to achieve this, but one, according to exemplary embodiments hereof, is to first determine what parts of the game are suitable for a flow-state to occur, and then calculate the percentage of time the player's actual response matches the ideal response during those suitable parts of the game. Other approaches for scoring may take into account the duration of continuous matching of the player's actual response and the ideal response. For example, if a player's response matched 10 seconds of an ideal response for one particular section of a game, but the player was only matching at one second intervals at a time, then the player's flow-state score would be low. However, if the player matched the ideal response for a full 10 seconds uninterrupted (continuous), then the player would “score” higher.

### Therefore, if:

APRn=Actual Player Response for a specific tested segment (n) of gameplay; and
IPRn=Ideal Player Response for the tested segment (n) of gameplay; and
FSSn=Flow Segment Score for the tested segment (n) of gameplay=APRn/IPRn.

Total Flow Segment Score of the player during a particular duration of gameplay:

$$Total FSS = ( ( Sum of FSSn / ( n ) ) \times 100$$

According to exemplary embodiments hereof, this score would be calculated by the system at the end of gameplay and provided to the player for their review, along with any corresponding biometrics and performance metrics collected during the game.

According to exemplary embodiments hereof, the system may consider secondary factors, identified above, when calculating the flow-state score, such as eye-movement, heart rate or hand-grip intensity. Also, whichever method is used, the score is preferably presented to the player after the game has ended. An indication of playing in a flow-state condition may be presented to the player in real-time, but Applicants are concerned that the presentation will become a distraction to the player and actually distract the player out of their flow-state.

According to exemplary embodiments hereof, the system may detect only a portion of the player's response when compiling data points to be used to compare with ideal play response data. In the above example of the fitness game Supernatural, only the portions of a player's swing that intersect with objects 16a-16c, in the virtual world, will be compared to a predetermined ideal swing path. The portions of the player's swing between objects 16a-16c will not be evaluated since based on the rules of the game, the objects must be hit along hit direction 25 (in FIG. 7), and what the player does with virtual baton 14 otherwise should not matter.

### “Ghost”—Character Techniques:

A theory regarding “flow-state” while playing a game includes the premise that a flow-state may be achieved more easily when a player understands their own skill level or capabilities in the particular game, and the player is given a sufficient amount of challenge during gameplay to remain engaged in the game. When both of these factors are satisfied, the player has a strong potential to enter into a flow-state during gameplay. Some games, such as the above-identified and described “Supernatural” fitness game, allows the player to select a level of difficulty of gameplay prior to starting the game, but the player may not have the confidence to select a level of difficulty that truly matches their abilities, and therefore may never reach a flow-state. With these prior art games, a player may not know if he is capable of playing the game at any particular level.

To this end, and according to exemplary embodiments hereof, a so-called ghost image of a player avatar may be generated either adjacent to a player so that the player may easily see the avatar directly within their field of view while playing the game, or may easily turn their head within a VR game to see the ghost avatar, perhaps standing next to the player, when desired. According to these embodiments, the ghost avatar is a highly transparent (e.g., between 10% and 40% opaque) graphical representation of a person playing the particular game. The “real” player may see through the ghost avatar, but may also see enough detail of the avatar to understand the avatar's movements during gameplay.

The avatar may be programmed by the software of the system to play the game with movements that closely, or exactly match ideal gaming movements (following the ideal player response) for the particular game. Since the avatar is playing the same game as the player, the avatar's movements are in sync with the movements of the player. This provides the “real” player an instant comparison between the movements of a “perfect” player and their own gaming movements, in real time. This personal and immediate comparative instruction of gameplay not only helps a player improve their gaming movements, but also helps the player determine if they are capable of playing the game at a particular level of difficulty. The system may detect the differences between the ideal player-response of the avatar and the actual player-response by the real player and cause the game to pause and replay so that the avatar may teach the player the proper movement for any particular section of gameplay. The system may use A.I. to detect these differences and if the player appears less skilled for the particular level of difficulty, for example, the system may use A.I. to determine and then suggest to the player a level of difficulty that more closely matches, or may even be a bit more challenging than their capabilities. The system may learn overtime (or may be provided with data based on prior testing) the level of skill required to successfully perform various movements of various sections of a particular game. If the player cannot match the required movements for those particular sections of the game, the player may likely be playing beyond their capabilities. The A.I. will recommend a particular level that better suits the particular player's skills. This system allows the player to feel confident that they may play the game at the correct level of difficulty, one that best matches their skill and may therefore more easily achieve a flow-state. This same approach may also be used to push the player into slightly more difficult skill levels so that the player remains engaged and capably challenged.

The present system may also use other information of the player to help recommend the best skill-level for the player. This information may include collected biometrics and profile information, such as heart rate over a time period, heart rate recovery time, weight of the player, height and previous playing capabilities of the player. The system may also use game-rules to help adjust the player skill.

### Real-Time

Although the term “real time” may be used here, it should be appreciated that the system is not limited by this term or by how much time may actually be taken. In some cases, real-time computation may refer to an online computation, i.e., a computation that produces its answer(s) as data arrives, and generally keeps up with continuously arriving data. The term “online” computation is compared to an “offline” or “batch” computation.

### Computing:

The applications, services, mechanisms, operations, and acts shown and described above are implemented, at least in part, by software running on one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that may implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

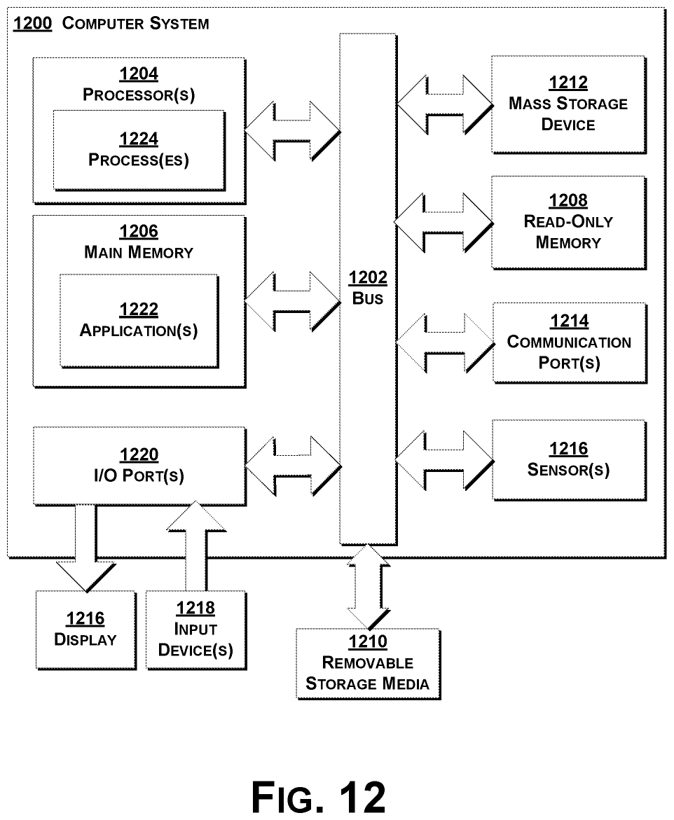

FIG. 12 is a schematic diagram of a computer system 1600 upon which embodiments of the present disclosure may be implemented and carried out.

According to the present example, the computer system 1600 includes a bus 1602 (i.e., interconnect), one or more processors 1604, a main memory 1606, read-only memory 1608, removable storage media 1610, mass storage 1612, and one or more communications ports 1614. Communication port(s) 1614 may be connected to one or more networks (not shown) by way of which the computer system 1600 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process may include, e.g., a processor and those devices such as input devices and output devices that are appropriate to perform the process.

Processor(s) 1604 may be any known processor, such as, but not limited to, an Intel® Itanium® or Itanium 2® processor(s), AMD® Opteron® or Athlon MP® processor(s), or Motorola® lines of processors, and the like. Communications port(s) 1614 may be any of an Ethernet port, a Gigabit port using copper or fiber, or a USB port, and the like. Communications port(s) 1614 may be chosen depending on a network such as a Local Area Network (LAN), a Wide Area Network (WAN), or any network to which the computer system 1600 connects. The computer system 1600 may be in communication with peripheral devices (e.g., display screen 1616, input device(s) 1618) via Input/Output (I/O) port 1620.

Main memory 1606 may be Random Access Memory (RAM), or any other dynamic storage device(s) commonly known in the art. Read-only memory (ROM) 1608 may be any static storage device(s) such as Programmable Read-Only Memory (PROM) chips for storing static information such as instructions for processor(s) 1604. Mass storage 1612 may be used to store information and instructions. For example, hard disk drives, an optical disc, an array of disks such as Redundant Array of Independent Disks (RAID), or any other mass storage devices may be used.

Bus 1602 communicatively couples processor(s) 1604 with the other memory, storage, and communications blocks. Bus 1602 may be a PCI/PCI-X, SCSI, a Universal Serial Bus (USB) based system bus (or other) depending on the storage devices used, and the like. Removable storage media 1610 may be any kind of external storage, including hard-drives, floppy drives, USB drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves, and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium may store (in any appropriate format) those program elements which are appropriate to perform the methods.

As shown, main memory 1606 is encoded with application(s) 1622 that support(s) the functionality as discussed herein (the application(s) 1622 may be an application(s) that provides some or all of the functionality of the services/mechanisms described herein. Application(s) 1622 (and/or other resources as described herein) may be embodied as software code such as data and/or logic instructions (e.g., code stored in the memory or on another computer readable medium such as a disk) that supports processing functionality according to different embodiments described herein.

During operation of an exemplary embodiment, processor(s) 1604 accesses main memory 1606 via the use of bus 1602 in order to launch, run, execute, interpret, or otherwise perform the logic instructions of the application(s) 1622. Execution of application(s) 1622 produces processing functionality of the service related to the application(s). In other words, the process(es) 1624 represents one or more portions of the application(s) 1622 performing within or upon the processor(s) 1604 in the computer system 1600.

For example, process(es) 1624 may include an AR application process corresponding to VR sharing application 230.

It should be noted that, in addition to the process(es) 1624 that carries (carry) out operations as discussed herein, other embodiments herein include the application(s) 1622 itself (i.e., the un-executed or non-performing logic instructions and/or data). The application(s) 1622 may be stored on a computer readable medium (e.g., a repository) such as a disk or in an optical medium. According to other embodiments, the application(s) 1622 may also be stored in a memory type system such as in firmware, read only memory (ROM), or, as in this example, as executable code within the main memory 1606 (e.g., within Random Access Memory or RAM). For example, application(s) 1622 may also be stored in removable storage media 1610, read-only memory 1608, and/or mass storage device 1612.

Those skilled in the art will understand that the computer system 1600 may include other processes and/or software and hardware components, such as an operating system that controls allocation and use of hardware resources.

As discussed herein, embodiments of the present invention include various steps or acts or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which may include hardware, software, firmware, or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, may cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

Although embodiments hereof are described using an integrated device (e.g., a smartphone), those of ordinary skill in the art will appreciate and understand, upon reading this description, that the approaches described herein may be used on any computing device that includes a display and at least one camera that may capture a real-time video image of a user. For example, the system may be integrated into a heads-up display of a car or the like. In such cases, the rear camera may be omitted.

### CONCLUSION

As used herein, including in the claims, the phrase “at least some” means “one or more,” and includes the case of only one. Thus, e.g., the phrase “at least some ABCs” means “one or more ABCs,” and includes the case of only one ABC.

The term “at least one” should be understood as meaning “one or more,” and therefore includes both embodiments that include one or multiple components. Furthermore, dependent claims that refer to independent claims that describe features with “at least one” have the same meaning, both when the feature is referred to as “the” and “the at least one.”

As used in this description, the term “portion” means some or all. So, for example, “A portion of X” may include some of “X” or all of “X.” In the context of a conversation, the term “portion” means some or all of the conversation.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only,” the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only,” the phrase “using X” does not mean “using only X.”

As used herein, including in the claims, the phrase “corresponds to” means “corresponds in part to” or “corresponds, at least in part, to,” and is not exclusive. Thus, e.g., the phrase “corresponds to factor X” means “corresponds in part to factor X” or “corresponds, at least in part, to factor X.” Unless specifically stated by use of the word “only,” the phrase “corresponds to X” does not mean “corresponds only to X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first” and “second” in the description and claims are used to distinguish or identify, and not to show a serial or numerical limitation. Similarly, the use of letter or numerical labels (such as “(a),” “(b),” and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise,” “including”,

“having”, and “contain” and their variations should be understood as meaning “including but not limited to” and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification may be combined in any combination, except for combinations where at least some of the features and/or steps are mutually exclusive. In particular, preferred features of the invention are applicable to all aspects of the invention and may be used in any combination.

Reference numerals have just been referred to for reasons of quicker understanding and are not intended to limit the scope of the present invention in any manner.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1-26. (canceled)

27. A computer-implemented method for determining gameplay performance, the method comprising:
tracking movement of a select portion of a player in a physical environment of the player;
determining an actual-response path by the player during a gameplay in a virtual environment;
calculating, at a first time, an ideal-response path for the select portion of the player to follow during the gameplay in order for the player to achieve a predetermined level of performance;
comparing, at a second time, the actual-response path with the ideal-response path; and
determining, based on a match in the comparing, that the predetermined level of performance has been reached by the player.

28. The method of claim 27, further comprising changing a volume level of music played during the gameplay in response to the player reaching the predetermined level of performance.

29. The method of claim 28, wherein changing the volume level of the music includes attenuating the volume level from a first volume level played during the gameplay to a lower second volume level.

30. The method of claim 28, wherein the changing the volume level of the music includes increasing the volume level of the music from a first volume level to a higher third volume level.

31. The method of claim 27, further comprising changing at least one visual characteristic of the virtual environment, in response to the player reaching the predetermined level of performance.

32. The method of claim 31, wherein the at least one visual characteristic includes at least one of (i) blurring at least a portion of an image that makes up the virtual environment, (ii) darkening at least a portion of the image that makes up the virtual environment, or (iii) changing at least 50% of pixels of the image that makes up the virtual environment to a common color.

33. The method of claim 27, further comprising displaying a sponsored image for the player to view during the gameplay.

34. The method of claim 27, transforming, in response to the player reaching the predetermined level of performance, a shape or image that conveys a sponsoring brand.

35. The method of claim 27, further comprising calculating the ideal-response path for the select portion of the player over a prescribed first period of time.

36. The method of claim 27, further comprising calculating the ideal-response path for the select portion of the player over a prescribed first and second periods of time.

37. The method of claim 27, wherein the select portion of the player includes at least one of facial muscles of the player, feet of the player, or audio signals in the physical environment.

38. The method of claim 27, further comprising changing, in response to the player reaching the predetermined level of performance, the gameplay from a first level of difficulty to a second level of difficulty.

39. A system comprising:
one or more processors; and
a memory storing instructions which, when executed by the one or more processors, cause the system to:
track movement of a select portion of a player in a physical environment of the player;
determine an actual-response path by the player during a gameplay in a virtual environment;
calculate, at a first time, an ideal-response path for the select portion of the player to follow during the gameplay in order for the player to achieve a predetermined level of performance;
compare, at a second time, the actual-response path with the ideal-response path; and
determine, based on a match in the comparing, that the predetermined level of performance has been reached by the player.

40. The system of claim 39, wherein the instructions, when executed by the one or more processors, cause the one or more processors to change, in response to the player reaching the predetermined level of performance, a volume level of music in the gameplay.

41. The system of claim 39, wherein the instructions, when executed by the one or more processors, cause the one or more processors to change at least one visual characteristic of the virtual environment, in response to the player reaching the predetermined level of performance, the at least one visual characteristic includes at least one of (i) blurring at least a portion of the image that makes up the virtual environment, (ii) darkening at least a portion of the image that makes up the virtual environment, or (iii) changing at least 50% of the pixels of the image that makes up the virtual environment to a common color.

42. The system of claim 39, wherein the instructions, when executed by the one or more processors, cause the one or more processors to display a sponsored image for the player to view during the gameplay.

43. The system of claim 39, wherein the instructions, when executed by the one or more processors, cause the one or more processors to transform, in response to the player reaching the predetermined level of performance, a shape or image that conveys a sponsoring brand.

44. The system of claim 39, wherein the select portion of the player includes at least one of facial muscles of the player, feet of the player, or audio signals in the physical environment.

45. The system of claim 39, wherein the instructions, when executed by the one or more processors, cause the one or more processors to change, in response to the player reaching the predetermined level of performance, the gameplay from a first level of difficulty to a second level of difficulty.

46. A non-transitory computer-readable storage media having computer-readable instructions stored thereon, the computer-readable instructions being executable by one or more processors to perform a method and cause the one or more processors to:
track movement of a select portion of a player in a physical environment of the player;
determine an actual-response path by the player during a gameplay in a virtual environment;
calculate, at a first time period, an ideal-response path for the select portion of the player to follow during the gameplay in order for the player to achieve a predetermined level of performance;
compare, at a second time period, the actual-response path with the ideal-response path; and
determine, based on a match in the comparing, that the predetermined level of performance has been reached by the player.
